(19) United States
(12) Patent Application Publication
(10) Pub. No.: US 2024/0020519 A1
(43) Pub. Date: Jan. 18, 2024

(54) TRAINING AND APPLICATION METHOD AND APPARATUS FOR NEURAL NETWORK MODEL, AND STORAGE MEDIUM

(71) Applicant: CANON KABUSHIKI KAISHA, Tokyo (JP)

(72) Inventors: Wei Tao, Beijing (CN); Tsewei Chen, Tokyo (JP); Deyu Wang, Beijing (CN); Lingxiao Yin, Beijing (CN); Dongyue Zhao, Beijing (CN)

(21) Appl. No.: 18/351,417

(22) Filed: Jul. 12, 2023

(30) Foreign Application Priority Data
Jul. 14, 2022 (CN) 202210831698.6

(51) Int. Cl. G06N 3/0495; G06N 3/084

(52) U.S. Cl. CPC G06N 3/0495; G06N 3/084

(57) ABSTRACT

The present disclosure provides training and application methods and apparatuses for a neural network model, and a storage medium. The training method includes: quantizing, in a forward transfer process, a network parameter represented by a continuous real value, and calculating a quantization error; determining, in a backward transfer process, a gradient of a weight in the neural network model; correcting the gradient of the weight based on the calculated quantization error, wherein the correcting includes correcting a magnitude of the gradient and correcting a direction of the gradient; and updating the neural network model according to the corrected gradient.

### CROSS-REFERENCE TO RELATED APPLICATIONS

This application claims priority to CN Application No. 202210831698.6, which was filed on Jul. 14, 2022 and which is incorporated by reference herein.

### TECHNICAL FIELD

The present disclosure relates to the field of modeling of deep neural networks (DNN), and in particular to a training method suitable for multi-layer low-bit quantization neural network model.

### BACKGROUND

A deep neural network is a model with a complex network architecture in the field of artificial intelligence, and is also one of the most widely used architectures at present. Common neural network models include convolutional neural network (CNN) models, recurrent neural network (RNN) models and graph neural network (GNN) models, and so on. The deep neural network has a multi-layer neural network structure, in which an output of a first layer of neurons becomes an input of a second layer of neurons, an output of the second layer of neurons becomes an input of a third layer of neurons, and the like. In addition, this multi-layer neural network may use back propagation to fine-tune parameters every time a layer is trained. Deep learning architecture has been widely applied in the fields of computer vision, computer hearing, and natural language processing, such as image classification, object recognition and tracking, image segmentation, speech recognition, and others.

However, operation of a deep neural network depends on a large amount of memory overhead and rich processor resources. Although deep neural networks can achieve better performance targets on GPU-based workstations or servers, these deep neural networks are generally not suitable for operating on resource-constrained embedded devices, such as smart phones, tablets, various handheld devices, and so on. Therefore, pruning/sparsification, low-rank factorization, quantization and other schemes can be used to optimize the model. Among them, the amount of calculation can be significantly reduced by quantization. However, for a low-bit quantization neural network, a quantization process of the forward calculation involves a step function in a training process, which step function is almost non-differentiable everywhere, which leads to the gradient of network parameters being 0 in a backward calculation process, thereby making the network lose its learning ability.

In order to solve the above problem that the step function is almost non-differentiable everywhere, the Straight Through Estimator (STE) algorithm proposes a gradient straight-through estimator, which directly transfers an accurate gradient of the error generated in a training process with respect to discrete quantization values to continuous real-valued parameters. The real-valued parameters perform parameter updating according to the obtained gradient in combination with corresponding learning strategy, so that the network can obtain continuous learning ability.

CN111523637A provides a network binarization algorithm IR-Net for optimizing information flow in forward/back propagation. This method introduces, in the forward propagation process, a balanced standardized quantization method called Libra parameter binarization, wherein a Bernoulli distribution with a parameter P=0.5 is used to maximize information entropy of quantization parameters and minimize a quantization error, and an error attenuation estimator instead of the straight-through estimator is used in the back propagation process to calculate the gradient, so as to ensure a full update at the beginning of training and an accurate gradient at the end of training.

However, in the above-mentioned two methods, the goal of network optimization is focused on minimizing the quantization error generated by the forward propagation, while the influence of the quantization error on gradient calculation is ignored.

In order to enable a deep neural network to operate on resource-constrained embedded devices such as smart phones, tablets, and various handheld devices, the following schemes may generally be adopted to optimize the model. Pruning/sparsification: in a process of training the network, unimportant connection relations are pruned, most of weights in the network become 0, and the model is stored in a sparse mode. Pruning may be implemented at different levels according to different tasks, such as weight level, channel level, layer level, and so on. Low-rank factorization: low-rank factorization is performed with a structured matrix, so that a full-rank matrix which was originally dense can be represented as a combination of several low-rank matrices, and the low-rank matrix can be factorized into a product of small-scale matrices. Quantization: a lower bit width (1 bit, 2 bits, or other bits) is used to represent a floating-point number with 32 bits or higher precision, so as to map continuous real values in feature maps and network parameters to discrete integer values, thereby significantly reducing the storage space for parameters and the occupation space of memory, speeding up the operation, and reducing the power consumption of devices. Knowledge distillation: knowledge of a large network model with good performance is transferred to a small network model through transfer learning, so that the small network model achieves a performance comparable to that of the large network model, thereby greatly reducing the computing cost. Compact model architecture: a network layer with a special structure is constructed, and training is performed from the beginning to obtain network performance suitable for deployment onto resource-constrained devices, which has no need to store a pre-trained model specially and to improve performance through fine tuning, thereby reducing the time cost, and it has the characteristics of small storage amount, low computing amount and good network performance.

Compared with other technologies, the quantization technology has its specific advantages among the above technical solutions. Especially for the 1-bit weight quantization technology, weight parameters are quantized into only two states, i.e., +1 and −1, which greatly simplifies the convolution operation that originally requires multiplication and addition operations to only an addition operation process, thereby significantly reducing the computing amount.

However, in the prior art, when solving the technical problem that it is difficult to train a low-bit quantization neural network, the only focus is to minimize the quantization error generated by forward propagation, while the influence of quantization error on gradient calculation is not considered.

### SUMMARY

Since the known methods have the above problems, the present disclosure proposes a training method for a multi-layer neural network. Compared with the above methods, the method of the present disclosure has better performance particularly in reducing the inconsistency of forward/backward calculations in a training process of a low-bit quantization neural network.

According to an aspect of the present disclosure, a training method for a neural network model is provided, which is characterized by comprising: quantizing, in a forward transfer process, a network parameter represented by a continuous real value, and calculating a quantization error; determining, in a backward transfer process, a gradient of a weight in the neural network model; correcting the gradient of the weight based on the calculated quantization error, wherein the correcting comprises correcting a magnitude of the gradient and correcting a direction of the gradient; and updating the neural network model according to the corrected gradient.

According to another aspect of the present disclosure, a training apparatus for a neural network model is provided, which is characterized by comprising: a quantizing unit configured to quantize, in a forward transfer process, a network parameter represented by a continuous real value, and calculate a quantization error; a gradient determining unit configured to determine, in a backward transfer process, a gradient of a weight in the neural network model; a gradient correcting unit configured to correct the gradient of the weight based on the calculated quantization error, wherein the correcting comprises correcting a magnitude of the gradient and correcting a direction of the gradient; and an updating unit configured to update the neural network model according to the corrected gradient.

According to another aspect of the present disclosure, an application method of a neural network model is provided, which comprises: storing a neural network model trained based on the above training method; receiving a data set corresponding to a requirement of a task that the stored neural network model is capable of performing; performing operations on the data set in layers from top to bottom in the stored neural network model, and outputting a result.

According to another aspect of the present disclosure, an application apparatus of a neural network model is provided, which comprises: a storing module configured to store a neural network model trained based on the above training method; a receiving module configured to receive a data set corresponding to a requirement of a task that the stored neural network model is capable of performing; a processing module configured to perform operations on the data set in layers from top to bottom in the stored neural network model, and output a result.

According to another aspect of the present disclosure, a non-temporary computer-readable storage medium storing instructions is provided, the instructions when executed by a computer, causing the computer to perform the above training method for a neural network model.

Other features of the present disclosure will become apparent from the following description of exemplary embodiments with reference to the accompanying drawings.

### BRIEF DESCRIPTION OF THE DRAWINGS

The accompanying drawings incorporated in and forming a part of the specification show exemplary embodiments of the present and are used to explain the principles of the present disclosure together with the description of the exemplary embodiments.

FIG. 1 illustrates a block diagram of a hardware construction according to an exemplary embodiment of the present disclosure.

FIG. 2 illustrates a flowchart of a training method for a neural network model according to a first exemplary embodiment of the present disclosure.

FIGS. 3A-3C illustrate neural network model architectures.

FIGS. 4A-4C illustrate multi-layer neural network structures according to the first exemplary embodiment of the present disclosure.

FIG. 5 illustrates a flowchart of quantization processing of the first exemplary embodiment of the present disclosure.

FIGS. 6A-6F illustrate schematic diagrams of gradient correction processing of the first exemplary embodiment of the present disclosure.

FIG. 7 illustrates a schematic diagram of a training system of a second exemplary embodiment of the present disclosure.

FIG. 8 illustrates a schematic diagram of a training apparatus of a third exemplary embodiment of the present disclosure.

FIG. 9 illustrates a schematic diagram of a hardware environment of the training apparatus of the third exemplary embodiment of the present disclosure.

### DETAILED DESCRIPTION

Exemplary embodiments of the present disclosure will be described below in conjunction with the accompanying drawings. For clarity and conciseness, not all features of the embodiments are described in the specification. However, it should be understood that many implementation-specific settings must be made during the implementation of the embodiments in order to achieve specific goals of developers, such as meeting the restrictive conditions related to equipment and business, and these restrictive conditions may change with different implementations. In addition, it should also be understood that although the development work may be very complicated and time-consuming, it is only a routine task for those skilled in the art who benefit from the contents of the present disclosure.

Here, it should also be noted that in order to avoid obscuring the present disclosure due to unnecessary details, only the processing steps and/or system structures closely related to at least the scheme according to the present disclosure are shown in the accompanying drawings, while other details not very relevant to the present disclosure are omitted.

(Hardware Construction)

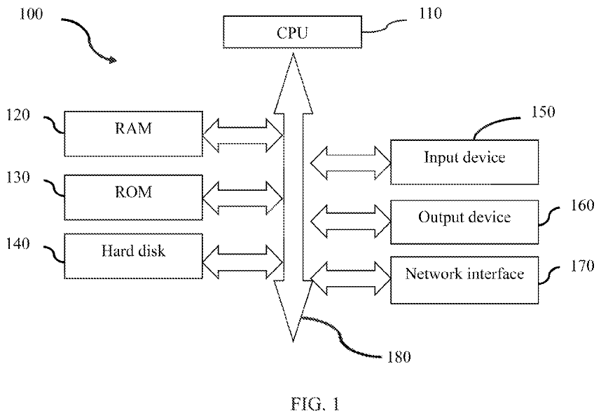

First, a hardware construction that can implement the technology described below will be described with reference to FIG. 1.

A hardware construction 100 includes, for example, a central processing unit (CPU) 110, a random-access memory (RAM) 120, a read-only memory (ROM) 130, a hard disk 140, an input device 150, an output device 160, a network interface 170, and a system bus 180. In one implementation, the hardware construction 100 may be implemented by a computer, such as a tablet computer, a notebook computer, a desktop computer, or other suitable electronic device.

In one implementation, an apparatus for training a neural network model according to the present disclosure is constructed by hardware or firmware and is used as a module or component of the hardware construction 100. In another implementation, a method for training a neural network model according to the present disclosure is constructed by software stored in the ROM 130 or hard disk 140 and executed by the CPU 110.

The CPU 110 is any suitable programmable control device (such as a processor) and can perform various functions to be described below by executing various applications stored in the ROM 130 or hard disk 140 (such as a memory). The RAM 120 is used to temporarily store programs or data loaded from the ROM 130 or hard disk 140, and is also used as a space for CPU 110 to perform various processes and other available functions. The hard disk 140 stores a variety of information, such as operating systems (OS), various applications, control programs, sample images, trained neural networks, predefined data (e.g., threshold values (THs)), and so on.

In one implementation, the input device 150 is used to allow a user to interact with the hardware construction 100. In one example, the user may input sample images and labels of the sample images (for example, area information of an object, category information of the object, etc.) through the input device 150. In another example, the user may trigger the corresponding processing of the present disclosure through the input device 150. In addition, the input device 150 may be implemented in a variety of forms, such as buttons, keyboards, or touch screens.

In one implementation, the output device 160 is used to store a finally trained neural network into, for example, the hard disk 140 or to output a finally generated neural network to subsequent image processing, such as object detection, object classification, image segmentation, etc.

The network interface 170 provides an interface for connecting the hardware construction 100 to a network. For example, the hardware construction 100 may perform data communication with other electronic devices connected via the network through the network interface 170. Optionally, a wireless interface may be provided for the hardware construction 100 for wireless data communication. The system bus 180 can provide a data transmission path for transmitting data between the CPU 110, the RAM 120, the ROM 130, the hard disk 140, the input device 150, the output device 160 and the network interface 170, etc. Although referred as a bus, the system bus 180 is not limited to any specific data transmission technology.

The above hardware construction 100 is only illustrative and is not intended to limit the present disclosure and its application or use. Furthermore, for simplicity, only one hardware construction is shown in FIG. 1. However, multiple hardware constructions may also be used as needed, and the multiple hardware constructions may be connected through a network. In this case, the multiple hardware constructions may be implemented by computers (e.g., cloud servers) or embedded devices, such as cameras, video cameras, personal digital assistants (PDAs), or other appropriate electronic devices.

Next, various aspects of the present disclosure will be described.

### First Exemplary Embodiment

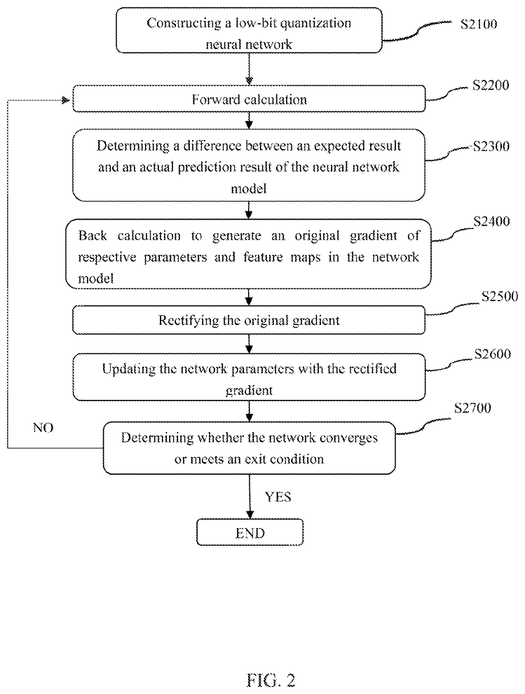

The training method of a neural network model according to the first exemplary embodiment of the present disclosure will be described below with reference to FIGS. 2-6. The specific description of the training method is as follows.

In order to reduce the inconsistency of forward/backward calculations in a training process of a low-bit quantization neural network and reduce the influence of the quantization error on the gradient calculation, the following scheme is adopted in some embodiments of the present disclosure.

First of all, a system defines a low-bit quantization neural network structure that contains at least a quantization convolution layer according to a target of a task, and the quantization convolution layer here may include both the quantization of convolution weight parameters and the quantization of a convolution output feature map.

Then, based on a training set and labeled data thereof, the system inputs a batch of data from the training set into the network, and the network performs once forward calculation. In the process of the forward calculation, a quantization process of the quantization convolution layer is divided into two steps: first, full-precision weight parameters represented by continuous real values in this layer are quantized into discrete values represented with lower precision, on which convolution calculation is then performed with input data; second, a feature map output from the convolution calculation is also quantized and converted into discrete values represented with low precision.

After the above forward calculation is completed, an error of network prediction is calculated according to an obtained prediction value and an actual value represented by the labeled data, and a back propagation is performed based on this error. In the process of back propagation, a gradient of parameters and a feature map is calculated layer by layer from back to front in the network, and the magnitude and direction of the gradient is rectified by a gradient rectifier according to the quantization error generated in the process of forward propagation, so as to obtain a more accurate gradient approximation, thus reducing the inconsistency of the forward/backward calculations, and enabling the network to obtain higher performance.

After the process of back propagation is completed, the network parameters are updated according to the rectified gradient and predefined network training strategy. The above steps of forward calculation, backward calculation and updating are performed iteratively until the network converges or an exit condition is met.

Referring to FIG. 2, the training method is specifically described as follows.

Step S2100: constructing a low-bit quantization neural network

According to a specific task requirement, this step creates a low-bit quantization neural network. In this network, at least one low-bit quantization convolution layer is contained. It should be noted that the low-bit mentioned in the present disclosure does not limit specific values, which may include 1 bit, 2 bits, etc., but is not limited to these values, and may be any value. The technical solution of the present disclosure may also be applied to other types of neural network models.

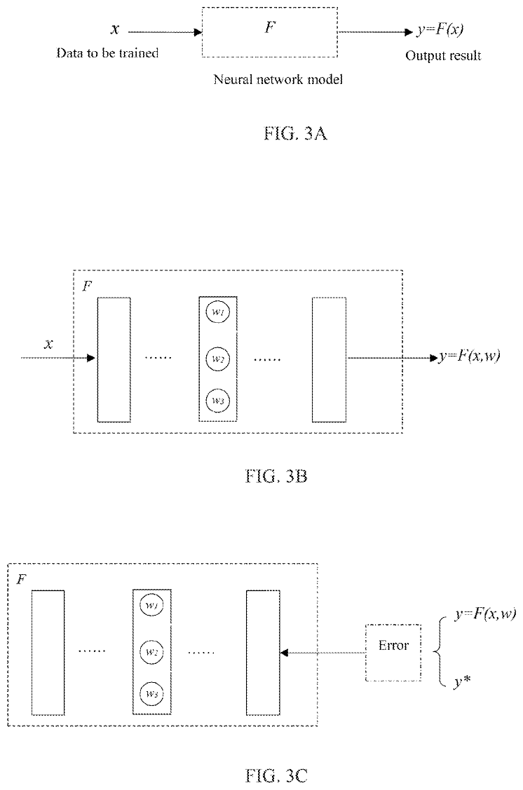

FIG. 3A illustrates a simple neural network model architecture (specific network architecture is not shown). After data x (feature map) to be trained is input into a neural network model F, operations are performed on x in the neural network model F layer by layer from top to bottom, and finally an output result y that meets a certain distribution requirement is outputted from the neural network model F.

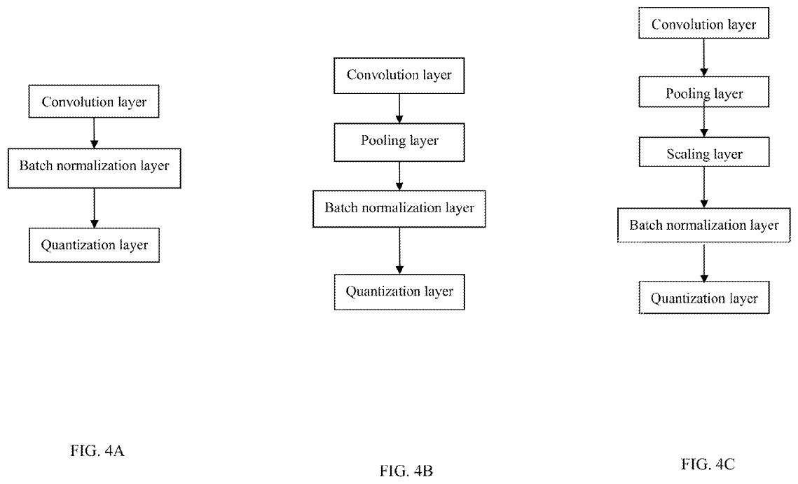

FIG. 4A describes a typical multi-layer neural network structure, which is composed of three parts: a convolution layer, a batch normalization layer, and a quantization layer. The convolution layer contains convolution weight parameters which are set as continuous real values represented by full precision when the network is initialized and, while in the process of forward calculation, these continuous real values are quantized as discrete values within a representation range determined by a bit width; the batch normalization layer normalizes an output result of the convolution layer into specific data distribution; and the quantization layer quantizes a continuous real-valued feature map output from the batch normalization layer to discrete values within the representation range determined by the bit width. According to another embodiment of the present disclosure, as shown in FIG. 4B, the structure may further include a pooling layer. According to yet another embodiment of the present disclosure, as shown in FIG. 4C, the structure may further include a scaling layer at which the feature map is scaled. It should be noted that the present disclosure is not intended to limit the above structures, and the above are only examples for illustration.

Step S2200: performing forward propagation of training

A training process of the neural network model is a cyclic and repetitive process. Each training includes three processes: forward propagation, back propagation, and parameter updating. Among them, the forward propagation is a process of inputting the data x to be trained into the neural network model, and performing operations on it layer by layer from top to bottom in the neural network model. The process of forward propagation described in the present disclosure may be a known process of forward propagation, and the process of forward propagation may include a quantization process of any bit of weight and feature map, which is not limited in the present disclosure. If a difference between an expected output result and an actual output result of the neural network model does not exceed a predetermined threshold, it means that the weights in the neural network model are the optimal solution, and the performance of the trained neural network model has reached the expected performance, so the training of the neural network model is completed. On the contrary, if the difference between the expected output result and the actual output result of the neural network model exceeds the predetermined threshold, then it needs to continue to perform the process of back propagation, that is, based on the difference between the expected output result and the actual output result, operations are performed layer by layer from bottom to top in the neural network model, and the weights in the model are updated, so that the performance of the network model after the weights are updated is closer to the expected performance.

Taking the convolutional neural network model shown in FIG. 3B and FIG. 3C as an example, it is assumed that there is a convolution layer including three weights w₁, w₂ and w₃ in the model. In the process of forward propagation shown in FIG. 3B, the input feature map of the convolution layer is convolved with the weights w₁, w₂ and w₃ respectively, so that the output feature map of the convolution layer is obtained and output to the next layer. Through layer-by-layer operation, the output result y of the network model is finally obtained. Comparing the output result y with the output result y* expected by the user, if an error therebetween does not exceed the predetermined threshold, it means that the current network model has a good performance; on the contrary, if the error therebetween exceeds the predetermined threshold, it is necessary to update the weights w₁, w₂ and w₃ in the convolution layer in the process of back propagation shown in FIG. 3C by using the error between the actual output result y and the expected output result y*, so as to make the performance of the network model better. Here, the updating process of the weights in the network model is the training process of the network model, that is, the updating process of the neural network.

The neural network model applicable to the present disclosure may be any known model, such as a convolutional neural network model, a recurrent neural network model, a graph neural network model, and the like. The present disclosure does not limit the type of network model.

The calculation precision of the neural network model applicable to the present disclosure may be any precision, that is, both high precision and low precision are applicable. The terms “high precision” and “low precision” means the relative level of precision, but do not limit specific values. For example, the high precision may be a 32-bit floating-point type, the low precision may be a 1-bit fixed-point type. Of course, other precisions such as 16-bit, 8-bit, 4-bit and 2-bit precisions are also included in the calculation precision range that the scheme of the present disclosure is applicable to. The term “calculation precision” may refer to the precision of the weights in the neural network model, or the precision of the input x to be trained, which is not limited in the present disclosure. The neural network model described in the present disclosure may be a binary neural network model (BNNs), and of course, it does not limit to neural network models with other calculation precision.

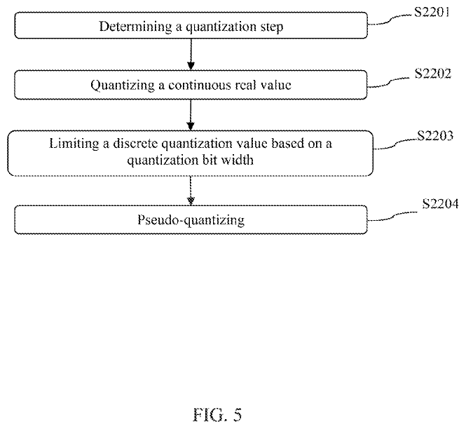

Unlike a training process of a network represented with full precision, the low-bit quantization neural network needs to quantize the weight parameters and feature map of the convolution layer in the process of forward calculation. Here, taking the uniform quantization of the feature map as an example, referring to FIG. 5, the quantization process of the forward calculation is as follows:

Step S2201: determining a quantization step Qₛₜₑₚ according to a quantization interval and a quantization bit width, the formula of which is as follows:

$${Q}_{step} = \frac{{boundary}_{up} - {boundary}_{low}}{{2}^{width} - 1} \qquad ( 1 )$$

wherein boundary up indicates an upper limit of the quantization interval, boundary_{low} indicates a lower limit of the quantization interval, width indicates the quantization bit width, and Qₛₜₑₚ is a quantization step obtained from calculation.
Step S2202: mapping a continuous real value without boundary restriction to a discrete quantization value Q, the formula of which is as follows:

$$Q = round ( \frac{R}{{Q}_{step}} ) \qquad ( 2 )$$

wherein R is the continuous real value without boundary restriction, round indicates a Rounding operation based on rounding off, and Q is the discrete quantization value.
Step S2203: limiting the discrete quantization value, wherein the discrete quantization value is limited within a range Q that can be expressed by the quantization bit width, and the formula of which is as follows:

Q=clip(Q,0,2^{width}−1) (3)

wherein in this step, the discrete quantization value obtained in step S2202 is further limited within the range that is representable by the quantization bit width.

Step S2204: pseudo-quantizing the discrete quantization value Q and restoring it to a floating-point quantization value FQ to continue to participate in subsequent network processes, the formula of which is as follows:

FQ=Q*Qₛₜₑₚ (4)

Step S2300: determining a difference between an expected result and an actual prediction result of the neural network model.

Step S2400: performing back calculation, wherein an original gradient g_{q} of respective parameters and feature maps in the network model is generated.

If the difference between the expected result and the actual prediction result of the neural network model calculated in step S2300 does not exceed the predetermined threshold, it means that the parameters in the neural network model have been the optimal solution, and then the training of the neural network is completed; on the contrary, if the difference exceeds the predetermined threshold, then it needs to continue to perform back calculation. A chain rule is used to calculate the gradient of the weight parameters and the feature maps layer by layer from back to front in the neural network model, and update the parameters in the model. In particular, for the low-bit quantization convolution layer, the STE (gradient estimation) is used for back propagation of the gradient.

Step S2500: rectifying. In this step, the gradient calculated in step S2400 is rectified. If the quantization error generated in the process of forward calculation is not considered and the network parameters are updated based on the original gradient, it will cause more serious inconsistency of forward/backward calculations. In order to obtain more accurate gradient approximation, the direction and the magnitude of the original gradient g_{q} are rectified based on the quantization error Error_{quant}, and the Rectifled_Grad_{direction} and Rectified_Grad_{magnitude} after the rectification can be seen in the following formulas:

Error_{quant}=Xᵣ−X_{q} (5)

Rectifled_G rad_{direction}=[sign(g_{q})*sign(Error_{quant})]* sign(g_{q}) (6)

Rectified_G rad_{magnitude}=(1+λ*sign(g_{q})*Error_{quant})*|g_{q}| (7)

wherein Xᵣ indicates the continuous real value before the quantization operation; X_{q} indicates the discrete value after the quantization operation, which corresponds to the floating-point quantization value FQ calculated in step S2204; Error_{quant} indicates the quantization error; g_{q} is the original gradient calculated in step S2400; sign is a sign taking operation; and λ is a modulation factor of the quantization error and is used to control the influence degree of the quantization error on the gradient magnitude, which can be either an empirical value or a value related to the learning rate.

The following proposes four cases to discuss the process of gradient rectification respectively. It should be noted that, when Xᵣ equals X_{q}, there is no quantization error, and then the gradient transferred through the STE is the correct gradient without error, and it is not necessary to rectify the gradient. When Xᵣ is not equal to X_{q}, there is a quantization error, and the gradient needs to be rectified.

The first case: the original gradient is greater than 0, that is, the original gradient points to a positive direction, and the continuous real value Xᵣ before the quantization operation is less than its corresponding discrete value X_{q} after the quantization operation, i.e., g_{q}>0, Xᵣ<X_{q}. In this case, the learning rate is indicated by η, and according to the updating manner of the STE, the updated parameter values X̅_̅{̅q̅}̅ and X̅ᵣ̅₋̅ₛ̅ₜ̅ₑ̅ are expressed by the following formulas:

X̅_̅{̅q̅}̅=X_{q}−η*g_{q} (8)

X̅ᵣ̅₋̅ₛ̅ₜ̅ₑ̅=Xᵣ−η*g_{q} (9)

In order to make the value of the updated Xᵣ approach X̅_̅{̅q̅}̅, the gradient of Xᵣ needs to be rectified.

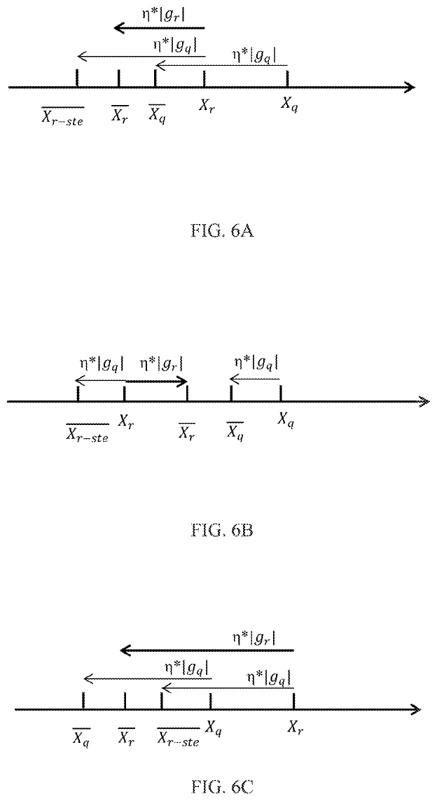

The following will describe the rectification of the gradient when X̅_̅{̅q̅}̅ is less than Xᵣ in the first case with reference to FIG. 6A. In order to make the value of the updated Xᵣ approach X̅_̅{̅q̅}̅, Xᵣ needs to be updated along a negative direction, that is, the direction of the rectified gradient needs to be the opposite positive direction, and now the direction of the original gradient is also the positive direction, so it is not necessary to modify the direction of the original gradient at this time. For magnitude rectification, since both X_{q} and Xᵣ need to be updated along the negative direction, and at the same time, Xᵣ is less than X_{q}, according to the following formula, only the reduction of the magnitude of the updated Xᵣ can make the updated Xᵣ approach X̅_̅{̅q̅}̅,

sign(g_{q})*Error_{quant}<0 (10)

At this time, the magnitude of the rectified gradient can be reduced.

The following will describe the rectification of the gradient when X̅_̅{̅q̅}̅ is greater than Xᵣ in the first case with reference to FIG. 6B. In order to make the value of the updated Xᵣ approach X̅_̅{̅q̅}̅, Xᵣ needs to be updated along the positive direction, that is, the direction of the rectified gradient needs to be the opposite negative direction, and now the direction of the original gradient is the positive direction, so the direction of the original gradient needs to be modified in accordance with the opposite direction at this time. For magnitude rectification, since after direction rectification, the updated Xᵣ has been closer to X̅_̅{̅q̅}̅ compared with the situation without direction rectification, it is set at this time that λ=0 to keep the magnitude of the gradient unchanged.

The second case: the original gradient is greater than 0, that is, the original gradient points to the positive direction, and the continuous real value Xᵣ before the quantization operation is greater than its corresponding discrete value X_{q} after the quantization operation, i.e., g_{q}>0, Xᵣ>X_{q}. In this case, according to the updating manner of the STE, obviously, X̅_̅{̅q̅}̅ is less than Xᵣ.

The following will describe the rectification of the gradient in this case with reference to FIG. 6C. In the case that X̅_̅{̅q̅}̅ is less than Xᵣ, in order to make the updated Xᵣ approach X̅_̅{̅q̅}̅, Xᵣ needs to be updated along the negative direction, that is, the direction of the rectified gradient needs to be the opposite positive direction, and now the direction of the original gradient is the positive direction, so it is not necessary to modify the direction of the original gradient at this time. For magnitude rectification, since both X_{q} and Xᵣ need to be updated along the negative direction, and at the same time, Xᵣ has been greater than X_{q}, according to the following formula, only the increase of the magnitude of the updated Xᵣ can make the updated Xᵣ approach X̅_̅{̅q̅}̅.

sign(g_{q})*Error_{quant}>0 (11)

The third case: the original gradient is less than 0, that is, the original gradient points to the negative direction, and the continuous real value Xᵣ before the quantization operation is less than its corresponding discrete value X_{q} after the quantization operation, i.e., g_{q}<0, Xᵣ<X_{q}. In this case, according to the updating manner of the STE, obviously, X̅_̅{̅q̅}̅ is greater than Xᵣ.

The following will describe the rectification of the gradient in this case with reference to FIG. 6D. In the case that X̅_̅{̅q̅}̅ is greater than Xᵣ, in order to make the updated Xᵣ approach X̅_̅{̅q̅}̅, Xᵣ needs to be updated along the positive direction, that is, the direction of the rectified gradient needs to be the opposite negative direction, and now the direction of the original gradient is the negative direction, so it is not necessary to modify the direction of the original gradient at this time. For magnitude rectification, since both X_{q} and Xᵣ need to be updated along the positive direction, and at the same time, Xᵣ has been less than X_{q}, according to the following formula, only the increase of the magnitude of the updated Xᵣ can make the updated Xᵣ approach X̅_̅{̅q̅}̅.

sign(g_{q})*Error_{quant}>0 (12)

The fourth case: the original gradient is less than 0, that is, the original gradient points to the negative direction, and the continuous real value Xᵣ before the quantization operation is greater than its corresponding discrete value X_{q} after the quantization operation, i.e., g_{q}<0, Xᵣ>X_{q}.

The following will describe the rectification of the gradient when X̅_̅{̅q̅}̅ is less than Xᵣ in the fourth case with reference to FIG. 6E. In order to make the value of the updated Xᵣ approach X̅_̅{̅q̅}̅, Xᵣ needs to be updated along the negative direction, that is, the direction of the rectified gradient needs to be the opposite positive direction, and now the direction of the original gradient is the negative direction, so the direction of the original gradient needs to be modified in accordance with the opposite direction at this time. Since after direction rectification, the updated Xᵣ has been closer to X̅_̅{̅q̅}̅ compared with the situation without direction rectification, it is set at this time that λ=0 to keep the magnitude of the gradient unchanged.

The following will describe the rectification of the gradient when X̅_̅{̅q̅}̅ is greater than Xᵣ in the fourth case with reference to FIG. 6F. In order to make the value of the updated Xᵣ approach X̅_̅{̅q̅}̅, Xᵣ needs to be updated along the positive direction, that is, the direction of the rectified gradient needs to be the opposite negative direction, and now the direction of the original gradient is the negative direction, so it is not necessary to modify the direction of the original gradient at this time. For magnitude rectification, since both X_{q} and Xᵣ need to be updated along the positive direction, and at the same time, Xᵣ is greater than X_{q}, according to the following formula, only the reduction of the magnitude of the updated Xᵣ can make the updated Xᵣ approach X̅_̅{̅q̅}̅.

sign(g_{q})*Error_{quant}<0 (13)

Step S2600: updating the network parameters with the rectified gradient.

Step S2700: determining whether the network converges or meets an exit condition. If yes, the training ends; otherwise, the step S2200 is performed.

In this embodiment, the steps S2200 to S2600 are repeated until the condition for ending the training is met. Here, the condition for ending the training may be any preset condition, for example, the difference between the expected output result and the actual output result of the neural network model not exceeding the predetermined threshold, or training times of the network model reaching a predetermined number, and so on.

It should be noted that the parameters of the network model in the first exemplary embodiment may be stored in advance, or obtained from the outside through a network, or obtained through local operations, which is not limited in the present disclosure. The parameters include, but are not limited to, the calculation precision, the learning rate vi, and the like, of the network model.

Through the scheme of the first exemplary embodiment of the present disclosure, even if the calculation precision of the neural network model is low, it can achieve good effects. In traditional technologies, the quantization function in a low-bit quantization neural network is non-differentiable, and its gradient needs to be approximated during training. The STE algorithm directly transfers a gradient, which leads to the inconsistency of forward and back calculations in the whole network training process. Therefore, for the STE algorithm, the direct transfer of the gradient is accurate only when the quantization error is zero, while the calculation of the gradient needs to be rectified according to the magnitude and direction of the error when the quantization error is not zero, so that the network parameters may be optimized along the correct magnitude and direction. As the number of training iterations increases, the IR-Net simulates a gradual evolution of a hyperbolic tangent function's derivative curve from the STE to a step function by changing a coefficient of the hyperbolic tangent function, which alleviates the inconsistency of the STE algorithm to some extent, but the goal of the network optimization is focused on minimizing the quantization error generated by forward propagation without consideration of the influence of the quantization error on the gradient calculation.

Through the scheme of the first exemplary embodiment of the present disclosure, the magnitude and direction of the gradient are rectified in the process of back propagation according to the quantization error generated in the process of forward propagation, so as to obtain a more accurate gradient approximation, thereby reducing the inconsistency of forward/back calculations and making the network obtain higher performance.

Traditional quantization methods convert a continuous real value to a nearest discrete integer value based on a quantization step that is statistic or learned by the network. These methods often focus on how to reduce the quantization error in the forward process through, for example, a normalization operation without affine transformation, so that the output feature map conforms to a standard normal distribution of zero mean and unit variance. At the same time, these methods generally lack a gradient optimization process in a back process, resulting in the mismatch of gradient transfer in the forward and back processes.

Table 1 and Table 2 show the performance comparison between the traditional technologies and the method according to the present disclosure in image classification. Alexnet and resnet-18 are used as backbone networks respectively, in which the first layer and the last layer maintain full precision and the middle layer uses 2-bit weight and 2-bit feature map, to train an ImageNet image classification network respectively. Accuracies of Top1 Accuracy and Top5 Accuracy are used as basic evaluation indicators, as shown in Table 1 and Table 2. Compared with the following traditional technologies, the recognition precision of the method according to the present disclosure is significantly improved.

TABLE 1

| | Top1 Accuracy | Top5 Accuracy |
|---|---|---|
| HWGQ | 53.93% | 74.59% |
| PACT | 55.00% | 77.70% |
| QIL | 58.1% | — |
| The present disclosure | 61.23% | 82.11% |

TABLE 2

| | Top1 Accuracy |
|---|---|
| PACT | 64.4% |
| QIL | 65.7% |
| DSQ | 65.2% |
| IRNet (EDE) | 66.8% |
| The present disclosure | 67.16% |

In the aspect of face feature point detection, face feature point detection models in four directions (up, down, left, right) are trained respectively, in which 300 W is used as a training set, and a mixed-precision low-bit network is used as the backbone network. According to the comparative data in Tables 3-6, it can be seen that the detection precision of the method according to the first exemplary embodiment of the present disclosure is significantly improved compared with the traditional technology.

TABLE 3

| Up direction | P = 3 | P = 4 | P = 5 | P = 6 |
|---|---|---|---|---|
| STE/Soft STE | 8.95 | 34.38 | 61.41 | 79.46 |
| Method of the | 10.03 | 34.95 | 63.06 | 81.75 |
| present disclosure | | | | |

* P indicates a coordinate error, in units of pixels, of a feature point allowed by the system.

TABLE 4

| Down direction | P = 3 | P = 4 | P = 5 | P = 6 |
|---|---|---|---|---|
| STE/Soft STE | 3.71 | 18.89 | 41.47 | 62.7 |
| Method of the | 4.69 | 19.87 | 44.11 | 65.79 |
| present disclosure | | | | |

TABLE 5

| Left direction | P = 3 | P = 4 | P = 5 | P = 6 |
|---|---|---|---|---|
| STE/Soft STE | 7.05 | 27.32 | 53.48 | 73.62 |
| Method of the | 9.36 | 28.11 | 56.83 | 76.19 |
| present disclosure | | | | |

TABLE 6

| Right direction | P = 3 | P = 4 | P = 5 | P = 6 |
|---|---|---|---|---|
| STE/Soft STE | 5.26 | 23.55 | 48.33 | 69.72 |
| Method of the | 7.18 | 24.98 | 51.28 | 71.33 |
| present disclosure | | | | |

### Second Exemplary Embodiment

Based on the aforementioned first exemplary embodiment, a second exemplary embodiment of the present disclosure describes a training system for a network model, which includes a terminal, a communication network and a server, the terminal and the server communicating with each other through the communication network, the server using a locally stored network model to train a network model stored in the terminal online, so that the terminal may use the trained network model for real-time business. The following describes respective parts of the training system of the second exemplary embodiment of the present disclosure.

The terminal in the training system may be an embedded image acquisition device, such as a security camera, or a smart phone, PAD, etc. Of course, the terminal may not be a terminal with weak computing capabilities, such as an embedded device, but may be other terminals with strong computing capabilities. The number of terminals in the training system may be determined according to actual needs. For example, if the training system is to train security cameras in a mall, then all security cameras in the mall can be regarded as the terminals, and at this time, the number of terminals in the training system is fixed. For another example, if the training system is to train smart phones of users in a mall, then any smart phone connected to the mall's wireless local area network can be regarded as the terminal, and at this time, the number of terminals in the training system is not fixed. In the second exemplary embodiment of the present disclosure, the type and number of terminals in the training system are not limited, as long as a network model can be stored and trained in the terminal.

The servers in the training system may be high-performance servers with strong computing capabilities, such as cloud servers. The number of servers in the training system may be determined according to the number of terminals they serve. For example, if a number or a geographical distribution range of terminals to be trained in the training system is small, then the number of servers in the training system is small, such as only one server. If the number or the geographical distribution range of terminals to be trained in the training system is large, then the number of servers in the training system is large, such as an established server cluster. In the second exemplary embodiment of the present disclosure, the type and number of servers in the training system are not limited, as long as the server can store at least one network model and provide information for training the network model stored in the terminal.

The communication network in the second exemplary embodiment of the present disclosure is a wireless network or wired network for realizing information transfer between the terminal and the server. At present, all networks available for uplink/downlink transmissions between a network server and a terminal can be used as the communication network in this embodiment, and the second exemplary embodiment of the present disclosure does not limit the type and communication mode of the communication network. Of course, the second exemplary embodiment of the present disclosure is not limited to other communication modes. For example, a third-party storage area may be allocated for said training system so that when the terminal and the server are to transfer information to each other, the information to be transferred is stored in the third-party storage area, and the terminal and the server regularly read the information in the third-party storage area so as to realize the information transfer therebetween.

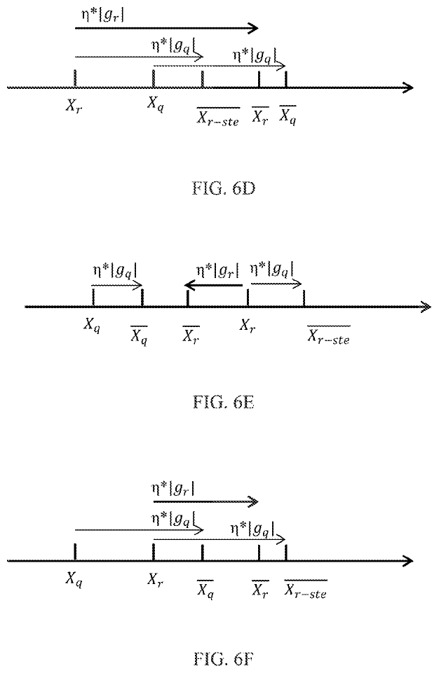

An online training process of the training system of the second exemplary embodiment of the present disclosure is described below in detail with reference to FIG. 7. FIG. 7 shows an example of the training system which is assumed to include a terminal and a server. The terminal can take real-time pictures, and it is assumed that the terminal stores a network model that can be trained and can process pictures, while the same network model is stored in the server. The training process of the training system is described as follows.

Step S201: the terminal issues a training request to the server through the communication network.

The terminal issues a training request to the server through the communication network that includes information such as a terminal identification. The terminal identification is the information that uniquely represents the identity of the terminal (for example, an ID or IP address of the terminal, etc.).

The step S201 is illustrated by taking one terminal issuing a training request as an example, and of course it is also possible that multiple terminals issue training requests in parallel. A process for multiple terminals is similar to that for one terminal, and will not be repeated here.

Step S202: the server receives the training request.

The training system shown in FIG. 7 includes only one server, so the communication network may transmit the training request issued by the terminal to the server. If the training system includes multiple servers, the training request may be transmitted to a relatively idle server according to the idle conditions of the servers.

Step S203: the server responds to the received training request.

The server determines the terminal that issues the request according to the terminal identification contained in the received training request, and then determines a network model to be trained stored in the terminal. An optional manner is that the server determines the network model to be trained stored in the terminal that issues the request according to a comparison table of terminals and network models to be trained; another optional manner is that the training request contains information about the network model to be trained, according to which the server may determine the network model to be trained. Here, determining the network model to be trained includes, but is not limited to, determining information characterizing the network model such as the network architecture, hyperparameters and the like of the network model.

After the server determines the network model to be trained, the method of the first exemplary embodiment of the present disclosure can be used to train the network model stored in the terminal that issues the request by using the same network model stored locally by the server. Specifically, the server locally updates weights in the network model according to the method of steps S2100 to S2700 in the first exemplary embodiment, and transmits the updated weights to the terminal, so that the terminal can synchronize the network model to be trained, and which is stored in the terminal, according to the received updated weights. Here, the network model in the server and the network model trained in the terminal may be the same network model, or the network model in the server may be more complex than the network model in the terminal while the outputs of these two network models are close to each other. The present disclosure does not limit the types of network models used for training in the server and the trained network models in the terminal, as long as the updated weights output from the server can synchronize the network model in the terminal, so that the output of the synchronized network model in the terminal is closer to an expected output.

In the training system shown in FIG. 7, the terminal actively issues the training request, while some embodiments of the present disclosure include a case in which the server broadcasts an inquiry message and then the terminal responds to the inquiry message to carry out the above training process.

In the training system described in the second exemplary embodiment of the present disclosure, the server may online train the network model in the terminal, thereby improving the flexibility of training; at the same time, it also greatly enhances the terminal's business processing capability and expands the terminal's business processing scenario. The above second exemplary embodiment describes the training system with online training as an example, but some embodiments use an offline training process, which is omitted here.

### Third Exemplary Embodiment

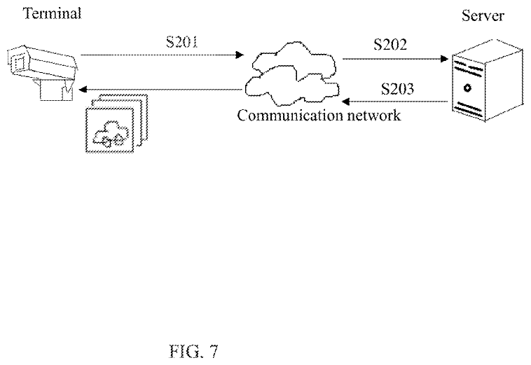

A third exemplary embodiment of the present disclosure describes a training apparatus for a neural network model which can perform the training method described in the first exemplary embodiment, and when the apparatus is applied in an online training system, it can be an apparatus in the server described in the second exemplary embodiment. A software structure of the apparatus is described below in detail with reference to FIG. 8.

The training apparatus in the third exemplary embodiment includes a quantizing unit 11, a gradient determining unit 12, a gradient correcting unit 13 and an updating unit 14. Among them, the quantizing unit 11 is used to quantize, in a forward transfer process, a continuous real value in a network parameter, and calculate a quantization error. The gradient determining unit 12 is used to determine, in back propagation, a gradient of a weight in the network model. The gradient correcting unit 13 is used to correct the gradient of the weight based on the calculated quantization error, wherein the correcting includes correcting a magnitude of the gradient and correcting a direction of the gradient. The updating unit 14 is used to update the weight by using the constrained gradient.

Preferably, the quantizing unit 11 is further used to determine a quantization step according to a quantization interval and a quantization bit width, map the continuous real value to a discrete quantization value, and limit the discrete quantization value in a range that is representable by the quantization bit width.

Preferably, the gradient correcting unit 13 is further used to calculate an updated value corresponding to the discrete quantization value, correct the direction of the gradient according to the updated value of the discrete quantization value and the continuous real value, and rectify the magnitude of the gradient according to the quantization error in the forward transfer process of the network.

The training apparatus of this embodiment also has modules for implementing the functions of the server in the training system, such as a function for recognizing the received data, a data encapsulation function, a network communication function, etc., which are omitted here.

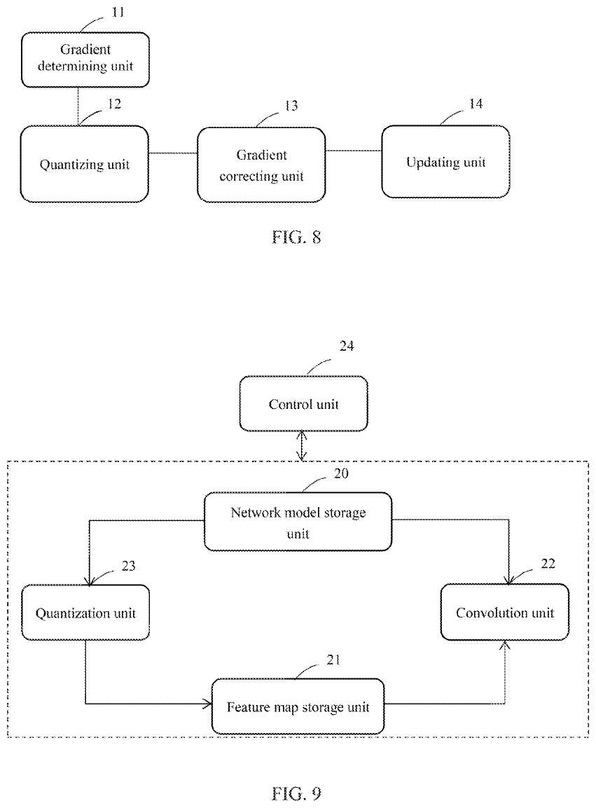

The training apparatus of the third exemplary embodiment of the present disclosure may operate in the structure shown in FIG. 9. When the structure shown in FIG. 9 receives a data set, it may process the received data set. If the difference between the final output result and the expected output result is large, then the training method described in the first exemplary embodiment is performed. Referring to FIG. 9, the hardware structure of the training apparatus includes a network model storage unit 20, a feature map storage unit 21, a convolution unit 22, a quantization unit 23, and a control unit 24. Each of these units is described below.

The network model storage unit 20 stores the hyperparameters of the network model to be trained as described in the first exemplary embodiment of the present disclosure, including but not limited to the following: the structure information of the network model, and the information required for operations in each layer (such as the calculation precision and learning rate η of the network model, and the like). The feature map storage unit 21 stores the feature map information required during operation by each layer in the network model.

In the forward propagation, the quantization unit 23 quantizes a continuous real value in a network parameter and calculates a quantization error. And in the back propagation, according to the method of the first exemplary embodiment, the gradient of the weight in the convolution layer is corrected according to the quantization error, and the weight in the convolution layer is updated with the corrected gradient.

The training apparatus may or may not further include a pooling/activation unit, or the training apparatus may or may not further include other units that can perform normalization and scaling, which will not be repeated here. If the layers managed by these units contain weights, then the weights in the layers can be updated during back propagation according to the method of the first exemplary embodiment.

The control unit 24 controls the operations of the network model storage unit 20 to the quantization unit 23 by outputting control signals to the respective units in FIG. 9.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The embodiments of the present disclosure may also be realized by the following method, that is, the software (program) that performs the functions of the above embodiments is provided to the system or apparatus through a network or various storage media, and the computer of the system or apparatus, or a central processing unit (CPU), a micro-processing unit (MPU), reads and executes the program.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

1. A method for a neural network model, the method comprising:
quantizing, in a forward transfer process, a network parameter represented by a continuous real value, and calculating a quantization error;
determining, in a backward transfer process, a gradient of a weight in a neural network model;
correcting the gradient of the weight based on the calculated quantization error, wherein the correcting comprises correcting a magnitude of the gradient and correcting a direction of the gradient; and
updating the neural network model according to the corrected gradient.

2. The method according to claim 1, wherein in the quantizing,
a quantization step is determined according to a quantization interval and a quantization bit width,
the continuous real value is mapped to a discrete quantization value, and
the discrete quantization value is limited in a range that is representable by the quantization bit width.

3. The method according to claim 1, wherein in the correcting of the gradient,
an updated value corresponding to a discrete quantization value is calculated,
the direction of the gradient is corrected according to the updated value of the discrete quantization value and the continuous real value, and
the magnitude of the gradient is corrected according to the quantization error in the forward transfer process of the network.

4. The method according to claim 3, wherein if a direction of the continuous real value pointing to the updated value of the discrete quantization value is consistent with the direction of the gradient, then in the correcting of the gradient, the direction of the gradient is corrected as an opposite direction of a direction of an original gradient, otherwise the direction of the gradient is maintained as the direction of the original gradient.

5. The method according to claim 3, wherein if the direction of the gradient is positive and the continuous real value is less than the discrete quantization value while being greater than the updated value of the discrete quantization value, or if the direction of the gradient is negative and the continuous real value is greater than the discrete quantization value while being less than the updated value of the discrete quantization value, then a magnitude of an original gradient is reduced, wherein the direction of the gradient is positive when a value of the gradient is positive.

6. The method according to claim 3, wherein if the direction of the gradient is positive and the continuous real value is greater than the discrete quantization value while also being greater than the updated value of the discrete quantization value, or if the direction of the gradient is negative and the continuous real value is less than the discrete quantization value while also being less than the updated value of the discrete quantization value, then a magnitude of an original gradient is increased.

7. The method according to claim 5, wherein in the correcting of the gradient, the calculated quantization error is scaled, and the gradient of the weight is corrected based on the scaled quantization error.

8. An apparatus for a neural network model, the apparatus comprising:
one or more storage media; and
one or more processors, wherein the one or more processors and the one or more storage media are configured to
quantize, in a forward transfer process, a network parameter represented by a continuous real value, and calculate a quantization error;
determine, in a backward transfer process, a gradient of a weight in a neural network model;
correct the gradient of the weight based on the calculated quantization error, wherein the correcting comprises correcting a magnitude of the gradient and correcting a direction of the gradient; and
update the neural network model according to the corrected gradient.

9. The method of claim 1, further comprising:
receiving a data set corresponding to a requirement of a task that the neural network model is capable of performing;
performing operations on the data set in layers from top to bottom in the neural network model; and
outputting a result.

10. The apparatus of claim 8, wherein the one or more processors and the one or more storage media are further configured to:
receive a data set corresponding to a requirement of a task that the neural network model is capable of performing;
perform operations on the data set in layers from top to bottom in the stored neural network model; and
output a result.

11. A non-transitory computer-readable storage medium storing instructions that, when executed by a computer, cause the computer to perform operations comprising:
quantizing, in a forward transfer process, a network parameter represented by a continuous real value, and calculating a quantization error;
determining, in a backward transfer process, a gradient of a weight in a neural network model;
correcting the gradient of the weight based on the calculated quantization error, wherein the correcting comprises correcting a magnitude of the gradient and correcting a direction of the gradient; and
updating the neural network model according to the corrected gradient.
